(19) United States
(12) Patent Application Publication
(10) Pub. No.: US 2002/0082930 A1
(43) Pub. Date: Jun. 27, 2002

(54) Method and apparatus for internet marketing and transactional development

(76) Inventor: Eric J. Park, Aliso Viejo, CA (US)

Correspondence Address: LEVIN & HAWES, P O BOX 4140, LAGUNA BEACH, CA, 92652

(21) Appl. No.: 09/740,753

(22) Filed: Dec. 18, 2000

(51) Int. Cl. G06F 17/60

(52) U.S. Cl. 705/26; 707/513

(57) ABSTRACT

A method for marketing over a network of interconnected computing/communicating devices is disclosed which may comprise the steps of: providing a web-site that is identified as specific to a market sector; supplying on the web-site information specific to a plurality of first level topics related to the market sector; providing within the information specific to a particular first level topic related to the market sector, at least one pointer to a more specific second level topic referenced in the information specific to the first level topic; responsive to activation of the pointer, providing further information specific to the more specific second level topic; providing access to E-commerce access to transaction processing with at least one provider of goods and/or services referenced in the more specific second level topic. The method may further comprise the steps of: providing within the information specific to the second level topic at least one pointer to a more specific third level topic referenced in the information specific to the second level topic; responsive to the activation of the pointer contained within the information relating to the second level topic, providing further information specific to the more specific third level topic; providing E-commerce access to transaction processing with at least one provider of goods and/or services referenced in the more specific third level topic. The method may further comprise the steps of: providing within the information specific to an nth level topic at least one pointer to a more specific n+1th level topic referenced in the information specific to the nth level topic; responsive to the activation of the pointer contained within the information relating to the nth level topic, providing information relating to the n+1th level topic; providing E-commerce access to transaction processing with at least one provider of goods and/or services referenced in the more specific n+1th level topic. The network may be the World Wide Web. The identification of the web-site may include a superbrand designation, which may include a market category designator and a superbrand moniker, e.g. as a suffix and ,e.g., the suffix “pedia.”

### FIELD OF THE INVENTION

The present invention relates to the field of marketing over a network of interconnected computing/communication devices, e.g., the Internet, otherwise known as the World Wide Web (“www.”).

### BACKGROUND OF THE INVENTION

The Internet or World Wide Web (hereinafter “Web”) continues to mature as an avenue for communication and for the dissemination and acquisition of information. This includes utilization of the Web as a marketing and sales tool, both business-to-business (“B-B”) and business-to-consumer (“B-C”). These links have taken the form of portals and/or auctioning sites. In the former, a particularly broad category of providers of goods and/or services are listed in some fashion and perhaps abstracted in some fashion and links are provided to the site(s) of the listed providers. The user accessing the portal can choose one or more provider's sites to visit and thereby perhaps conduct business through well-known E-commerce techniques with such provider. In the latter type of site a provider or groups of providers of goods and/or services may solicit bids for these goods through a site or individuals or companies may place an object or service up for auction to the highest bidder. In various forms these two basic types of sites define present approaches to E-commerce transaction solicitation and subsequent processing to complete sales over the Web.

In “Pure Cyberspace,” a User could attain complete satisfaction in his or her search for information, products, or services. Such a user could “travel” through the use of images invoked by the user. Images are created by the thought process of the user from sensory components (sight, sound, touch, feel, etc.). The user could be enabled to arrive at a place (destination) in the frictionless universe of Cyberspace, which most closely approximates the composed image. At preliminary destination points, the user could find a very large number of variations or alternatives of the composed image, which in turn could allow the user to discover a final destination point that represents a total fulfillment of the user's image expectations. At this final destination point, the user is connected to virtually every possible imaginable transaction regarding the contemplated information, product, or service, in complete satisfaction of his or her needs and desires.

In such a Pure Cyberspace, E-Commerce could allow every User (consumer) to effortlessly find the best information, products, and services, of the best quality and convenience available, and at the best possible price. Providers/sellers of products and services in turn would have immediate access to all contemplating users, and the ability to seamlessly adjust their product or service, to fully meet the user's expectations of features, quality, convenience, and price. Competition among providers/sellers would result in ever increasing variety, quality, and price satisfaction.

E-Commerce on the Web is, however, constrained by the limitations of current Cyberspace Technology (as delimited by the Internet Protocol). Such technologies, including hostnames, URLS, Websites, Portals, and Search Engines, do not allow the user to fully or effectively and efficiently arrive at a contemplated destination. Portals have a “keyhole” effect designed to accommodate the common denominators among multitudinous users. Hostnames, URLS and Search Engines are both imprecise in attaching meaning to content, and numerous and improperly focused or unfocused, in view of the user's image. This results in many approximate destinations being discovered before the ultimately desired destination is reached, if it is at all. Hence, the description “surfing the Web.” Often, the user completely misses available information, products, and services simply because of the inefficiencies in the Cyberspace Technologies currently employed in the quest.

Likewise, providers/sellers of products and services on the Web can be constrained in their access to users. The “branding” of URLS (“hostnames”) is expensive, and constrained by the information overload caused by an ever increasing volume of information available to the user's mind. Access for providers/sellers to exposure on portals and through search engines is both costly and inefficient. Often the success of a provider/seller in locating users, or vice versa, is more dependent upon the size of advertising budgets than the variety, quality, and price satisfaction for the product or service.

“Domain” is an overused term in the Internet. It can be used in the Administrative Domain context, or the Domain Name context. As used herein it connotes the sense of the Domain Name System (“DNS”). The DNS is a general purpose distributed, replicated, data query service. The principal use is the lookup of host Internet Protocol (“IP”) addresses based on host names. The style of host names now used in the Internet is called “domain name,” because they are the style of names used to look up anything in the DNS. Some important domains are: .COM (commercial), .EDU (educational), .NET (network operations), .GOV (U.S. government), and .MIL (U.S. military). Most countries also have a domain. The country domain names are based on ISO 3166. For example, .US (United States), .UK (United Kingdom), .AU (Australia).

The Internet Protocol currently employs the DNS as an essential technology to locate data on the Web. It is therefore predominantly “linguistically” driven, rather than “image” driven (as might be the case in Pure Cyberspace). It is likely that the DNS in some shape or form will dominate the Web for years to come. Hence the “race” is underway to register “domain names” in every imaginable shape and form.

Domain names tend to fall into two categories: (1) coined “proper” names; and (2) descriptive or generic names. Both types have their own particular advantages and corresponding disadvantages. When the Internet was new, when there were few Websites up and running, when few people knew the names of any Websites, a generic name tended to be an advantage. If one wanted to look for a site selling shoes, one could type in “shoes.com.” This advantage has greatly diminished as a plethora of descriptive or generic domain names have flourished on the Web, and it has become exceedingly difficult to distinguish one generic name from another with a slight variation. Alternatively, “coined” or “proper” domain names often attach no particular relationship between the domain name and the subject matter of the Website found at the host name. A “proper” noun is a word that designates a particular being or thing. Mercedes-Benz is an example of a proper noun. Traditionally, brand names have been treated as having attributes of proper nouns. In the long run, the “branded” domain names are likely to be superior to the common or generic domain names. However, the disadvantage will continue to be the significant marketing and advertising costs to building the brand name on the Web or separately and then transposing it onto the Web.

In Cyberspace, information is the very stuff of space and time. Information transfers between spatiotemporal locations at ever increasing rates, in essence thus dissolving their very distinctness, as explained in Cyberspace: First Steps (1992) MIT, edited by Michael Benedikt, p. 23. In theory, Cyberspace is an environment of pure information (where human memory and identity are constantly transported globally without significant effort). The very existence of Cyberspace serves to transform post-industrial society toward a global information economy. The launch of the World Wide Web in March 1991, represented a significant development toward the full theoretical potential of Cyberspace. The recent prominence of the Internet and its progeny, the World Wide Web, have captured the public imagination as the so-called “information superhighway”, as set forth in U.S. Pat. No. 6,112,202—Method and system for identifying authoritative information resources. Within ten years of the Internet being opened to commercial usage, it has already provided us with a gigantic “Information Marketplace”, where individuals and organizations can buy, sell, and freely exchange information and information services among one another, as explained in Weaving the Web (1999) Tim Berners-Lee. Like Cyberspace, the Internet institutes a kind of virtual reality as a functional, objective component of physical reality: Internet interactions can have consequences that reach directly back into the physical world. The Internet is made possible by the hardware components and technology from which it physically is comprised, however it “exists” only at the level of human perception and experience. Ultimately, the technology itself is invisible.

It is already obvious that the Internet will continue to emerge, enlarge, expand, fill in, increase in complexity, and evolve, essentially indefinitely. The Internet involves a reversal of the earlier modes of interaction with computerized information, where information was external to the person. The Internet subverts that relation, people are now within information. The evolution of information on the Internet is becoming ubiquitous.

Moreover, the Internet offers a forum for people to gather in surprising personal proximity, with unrestricted freedom of expression and personal contact, with far less hierarchy and formality than is found in the primary social world. However, without appropriate definition, the risk becomes one of a man-made information jungle multiplying confusion through a maze of activities with no apparent coordination or organization. With information sprawl one's expectations can never be met, because one never knows what to expect.

Access to the various sources of information across the Internet is never really instant. One must find a point of entry, typically a “portal”. One must “navigate” around and through various websites, by a process of progressive information revelation. To a certain extent this constant accessing of new information sources, selecting among alternatives, with the corresponding element of surprise in such encounters, constitutes a good deal of the pleasure of the Internet experience called “surfing”.

Whether or not each individual achieves a net gain from all the effort expended in this “surfing” process, from the beginning the Internet was recognized as a rapidly evolving organism almost completely lacking in fundamental organization. Internet search tools were quickly created to answer the very pressing need to somehow organize all this very unstructured information resource. The authors bear this out in A Comparison of Seven Search Engines (1996) Eric T. Davis.

Numerous variations of the Internet “search engine” have been designed. The index or Boolean search allows the user to enter one or more keywords, which may be qualified by Boolean operators, in order to locate relevant content by matching the keywords with those appearing in the content. In contrast to index search services, category or directory search services group Web site content into specific categories, like an encyclopedia. The category search service collects information on Web site listings supplied by human editors, which is reviewed and placed into the appropriate categories, as for example in U.S. Pat. No. 6,078,866—Internet site searching and listing service.

Later, specialized or “niche search engines” were introduced as an alternative to the major Internet search engine sites. These search sites are typically devoted to a specific subject or niche, which can dramatically reduce the amount of “noise” returned in search results, often tens of thousands of citations. Niche sites search within a narrow universe of the Web. In theory, a “niche search engine” substantially increases the odds of quickly finding what you want. The only question is whether all the niche search boutiques can generate enough revenue to survive, e.g., as noted in “Let a Hundred Search Engines Bloom”, The Industry Standard (Jul. 24, 2000) Elinor Abreu.

Variations of the search methodology include site searching and listing services based on “monetary rankings” of the site. Subscribers are charged fees for having sites listed and ranked according to the amount of the subscription fees paid, for example as disclosed in, U.S. Pat. No. 6,078,866—Internet site searching and listing service. Another method involves sharing and organizing World Wide Web references using distinctive characters, as shown, e.g., in U.S. Pat. No. 6,138,128—Sharing and organizing world wide web references using distinctive characters. It has been contemplated that future search engines may constitute “thinking” machines: computer programs smart enough to compete with human intelligence. One aspect cited in favor of automated search methods is that they make human “tampering” with the search results extremely difficult, e.g., see “The Jimbo Awards ”, The Industry Standard (Jul. 24, 2000) James Fallows.

A countervailing view is that human intervention, through the organized employment of subject experts and information professionals to select, classify and catalogue Internet resources, is indispensable to aid effective search and retrieval for their users. Humans are a necessary confluence with the system (human-computer symbiosis) in order to amplify culturally and socially shared intelligence.

A web of data with meaning in the sense that a computer program can learn enough about what the data means to process it has been termed the “Semantic Web”, e.g., see Weaving the Web (1999) Tim Berners-Lee. Semantics, traditionally, consists in the way representations (icons, signs, or words) are meaningfully translated into values. While the semantic properties of computer interactions with data are significant, the semantic properties of the web as they relate to human interaction with information are even more intriguing.

On the Internet traditional reading is mutating into an active sampling of multiple media, and participation beckons at every corner. The great energy of “Web words”, their interactive dynamics, contrasts sharply with words published in other media. The Internet becomes the ultimate transformative writing technology. In a sense it represents a return to oral culture, where significant language is memorable language, often with a repeatable embodiment that makes it more or less permanent in the memories of speakers and listeners, see Electric Language (1987) Michael Heim.

Within this secondary electronic orality the residue of earlier forms of communication persists as integral moments in the whole configuration of a culture's communication network, as explained for example in Orality and Literacy: The Technologizing of the Word (1982) Walter J. Ong. Electronic writing and electronic language bring an abrupt shift in the psychic framework for human thought. See Electric Language (1987) Michael Heim.

This electronic language shift is ever critical to branding on the Internet. The most important marketing decision a business can make is what to name the product. See The 11 Immutable Laws of Internet Branding (2000) Al Reis and Laura Reis. In the case of the Internet, this becomes the critical decision of what to name the website. Today, communication itself is the problem. We have become the world's first overcommunicated society. The average mind is already like a dripping sponge that can only soak up more information at the expense of what's already there.

In the Internet age the name is critical. The Internet wipes out the visual. To tap into an Internet website, one need only type in a word. However, simply putting a name or other designator on the web, e.g., on a Website doesn't make it an Internet brand. There are brands and there are Internet brands, and the two are quite different. The secret to branding on the Internet, according to aspects of the present invention is the ability to present the brand in such a way that customers and prospects can interact with your message related to the brand, as noted in The 11 Immutable Laws of Internet Branding (2000) Al Reis and Laura Reis.

The consequences of so much instantaneous information available to consumers from this new source can be: (1) consumer empowerment, (2) middleman “displacement”, (3) a fundamental shift from “selling” to “facilitation”, and (4) information overload. Already the Internet has set in motion an unprecedented shift in power from the producers of goods and services to the customers who buy them, according to Net Gain: Expanding Markets Through Virtual Communities (1997) John Hagel, Arthur G. Armstrong. In this world of information abundance, attention can become a scare commodity. To create value for customers, information age companies working in networks or fluid congregations are in a constant search for new methods of collaborating, as noted, e.g., in Digital Capital (2000) Don Tapscott, David Ticoll & Alex Lowy.

Yet, the simple answer to the demand for new methods of business on the Internet is staring us in the face. If the Internet is interactive, and that's the revolutionary aspect of the medium, then for the first time the target is in charge, not the shooter. And what the target definitely does not want is more advertising arrows shot in its direction. What people want is information, see, e.g., The 11 Immutable Laws of Internet Branding (2000) Al Reis and Laura Reis.

When the inevitable “Internet shakeout” started early in the year 2000, it was suggested that companies with sound business models that were creating value for customers would survive, while those based on me-too ideas without a hope of ever making money would not. But now it isn't only the companies with “irrational” business models that are crashing and burning. Many of the so-called blue chips of the Internet Economy are being rattled to their core, as suggested in “Reports of the Death of the Dot-Com Have Been Greatly Exaggerated”, The Industry Standard (Oct. 30, 2000) Miguel Helft. In almost every case, scores of failed Internet companies have cited failure to effectively interact with customers or otherwise become known to customers or prospective customers on the Internet as the primary reason for their demise, the literal “burning” of billions of dollars on unsuccessful attempts to reach and retain customers.

The evolving paradigm for brand leadership calls for a strategic and visionary perspective, longer on the time horizon, moving from a traditional limited to a broad focus. Over multiple products and markets, complex brand architectures, a focus on multiple brands and a global perspective, the driver of brand strategy becomes customers and brand value rather than sales, see, e.g., Brand Leadership (2000) Aaker & Joachimsthaler.

With the “dot-com” explosion domain names are everything. “Branded” domain names identify portals, niche portals, community webs, business webs, gateways, auction sights, and individual businesses selling particular goods or services. Domain names have even been recognized as a method for identifying a related collection of web sites relating to a particular type of goods or services, as disclosed, e.g., in U.S. Pat. 6,125,395 —Method for identifying collections of internet web sites with domain names.

Recent discoveries suggest that a small number of rules or laws can generate systems of surprising complexity, known as complex adaptive systems, see, e.g., Emergence (1998) John H. Holland. They employ groups or sets of “agents” and are composed of many niches, each one of which can be exploited by an agent adapted to fill that niche. Each of the agents change and improve themselves relative to what all the other agents are doing, such that complex adaptive systems are characterized by perpetual novelty, see, e.g., Adaptation in Natural and Artificial Systems (1975) John H. Holland.

To transcend ever growing information sprawl, the Internet requires architecture and infrastructure; a substrate in which the integrity of its appearances and behaviors can be played out and extended within the context of individual expectations, needs, and desires. While the commercial world still largely thinks of the Internet as a “transaction” or product driven marketplace, the World Wide Web was conceived as an “information marketplace”, a medium that would codify, in its gigantic distributed information links, human knowledge and understanding, as suggested in Weaving the Web (1999) Tim Berners-Lee.

There exists a need for a more effective method for attracting potential customers to a site and for putting such customers in contact with a provider that is focused to the specific needs of the prospective customer, without the need for the prospective customer to spend significant amounts of time browsing listed sites, some of which may have little or no relevance to the actual products/services that the prospective customer is seeking to obtain information about and ultimately purchase.

### SUMMARY OF THE INVENTION

A method for marketing over a network of interconnected computing/communicating devices is disclosed which may comprise the steps of: providing a web-site that is identified as specific to a market sector; supplying on the web-site information specific to a plurality of first level topics related to the market sector; providing within the information specific to a particular first level topic related to the market sector, at least one pointer to a more specific second level topic referenced in the information specific to the first level topic; responsive to activation of the pointer, providing further information specific to the more specific second level topic; providing access to E-commerce access to transaction processing with at least one provider of goods and/or services referenced in the more specific second level topic. The method may further comprise the steps of: providing within the information specific to the second level topic at least one pointer to a more specific third level topic referenced in the information specific to the second level topic; responsive to the activation of the pointer contained within the information relating to the second level topic, providing further information specific to the more specific third level topic; providing E-commerce access to transaction processing with at least one provider of goods and/or services referenced in the more specific third level topic. The method may further comprise the steps of: providing within the information specific to an nth level topic at least one pointer to a more specific n+1th level topic referenced in the information specific to the nth level topic; responsive to the activation of the pointer contained within the information relating to the nth level topic, providing information relating to the n+1th level topic; providing E-commerce access to transaction processing with at least one provider of goods and/or services referenced in the more specific n+1th level topic. The network may be the world wide web. The identification of the web-site may include a superbrand designation, which may include a market category designator and a superbrand moniker, e.g. as a suffix and ,e.g., the suffix “pedia.”

### BRIEF DESCRIPTION OF THE DRAWINGS

FIG. 1 shows a schematic diagram of a matrix, which can consist of a collection of, e.g., three Internet websites;

FIG. 2 shows a schematic block diagram of a matrix, which can consist of a none-domain matrix;

FIG. 3 shows a schematic block diagram of a domain matrix with a four domain lattice;

FIG. 4a illustrates the properties of an exponential network and FIG. 4b illustrates the beneficial properties of a scale-free network according to the present invention.

### DETAILED DESCRIPTION OF THE PREFERRED EMBODIMENTS

Upon accessing an internet superbrand web-site according to the present invention, the user will be presented with a brief summary of the site and its content, such as “AUTOPEDIA™—The AUTOmotive encycloPEDIA—is the complete Internet source for automotive-related information, where consumers can find information related to Autos, Trucks, Minivans, Motorcycles, RV's and Sport Utilities.” These “information topics” are a general breakdown of the subsections of the internet superbrand web-site. The user will also have the opportunity to register in a Guest Registry and make comments and suggestions about the content of the web-site. Also on the opening page of the web-site is a banner that can contain, e.g., late breaking headlines and a hyper-link to a news service, or like information provider, or other advertising content, again with a link to an appropriate web-site associated with the provider of goods/services doing the advertising.

Also provided on the opening page of the internet superbrand web-site is a list of jump links to web-sites/web/pages with content as listed. The listed topics can include recent news items related to the above referenced information topics, self-help information on topics such as lemon laws, financing, negotiating, pricing, rebates, and the like associated with the above referenced information topics. A detailed list of such jump-link topics could include, by way of example, the following:

Autopedia Newsroom—News from Around the World

General Motors Recalls 3.5 million SUV's, pickups, vans

CARFAX: Check for Free if that Used Car you're thinking of buying is a lemon

CAR-Finder—Get the lowest price with no hassle

Export and Import—Exporting a Vehicle—The Ins and Outs

Auto Insurance Check Up—Are you paying too much?

Complete Auto, Truck, MiniVan and Sport Utility Information

Vehicle Pricing Including MSRP and Dealer Invoice Costs.

Financing and Leasing Information.

Negotiating Tips—How to Get the Absolute Best Deal.

Consumer Incentives and Rebates

Used Car Buyer's Checklist—Everything you need to know.

Warranty, Repair and Service.

Buying Tires? What owners have to say on our BBS

Stereos, Alarms, and Accessories

Loan Payment Calculators

Enthusiasts, Collectors and More

AUTOPEDIA SimulSearch

Recall Information—NHTSA Database

Autopedia Honored Guest Registry

Both NHTSA and IIHS crash test results

As noted above, included can be promotional materials, such as a promotion to “Get paid while you surf ! Cash for doing what you are already doing!” Also included can be traditional access to BBS, chats user registration, etc.

Following the list of jump link topics can be provided a short summary of each, which may be arranged in the order the jump links appear or in alphabetical order of the jump link topic names. As an example the site can provide in the summary of a jump link topic, such as “AUTO MANUFACTURERS” the content “AUTOPEDIA has the most up-to-date and complete listing of all of the manufacturer Internet sites available today, with more listings than any other directory! Some sites are slow, but if you have the patience - they are worth visiting. Or, if you want to contact the manufacturer, here are all of their toll-free 800 telephone numbers.” The underlined content forms a hyper-link to a web-page maintained by the provider of the internet superbrand web-site, which contains, respectively the list of manufacturer web-sites, and the 800 telephone listings. Clicking on either of these will take the user to the respective web pages and there are found further hyperlinks to the listed web-pages or to the respective web-page associated with a listed 800 telephone number. As another example the user can select the jump link topic “VEHICLE DIRECTORY” and be given information about and hyper-links to the sources of pricing information available about a selected vehicle make and model. Browsing through the various types and depths of information from the identified sources of, in this example, pricing information enables the users to review this information. This can include, in addition to other information, the Manufacturer's Suggested Retail Prices (MSRP's) and dealer invoice costs, and including such things as freight and suggested standard equipment packages. This information may also include such things as EPA mileage estimates, exterior and interior color availabilities, etc. Embedded in the summary may be pointers/hyper-links to other related topics, e.g., the calculation of auto-loan payments with various “Loan Payment Calculators”. Another example of a jump link topic might be a self-help tutorial on importing and exporting automotive products. This can include tips on the costs and the ins and outs of such a process, and tips on things to avoid. As another example, a self-help jump link topic could be “NEGOTIATING” with a hyper-link to a web-site/web-page containing useful information about negotiating techniques, which can be specific to the above referenced internet superbrand information topics. this could also include a hyper-link to a web-page of a service provider, e.g., “InterQuote-RFP Service.” This site might provide assistance in making a Request for Purchase, and may be provided by the provider of the Internet Superbrand web-site or by the providers of the goods and services that the user may wish to purchase associated with the particular jump link topic. In addition, this service could be provided by a third party service provider.

Another feature of the jump link topics is to provide a forum for user input in the form of comments about some aspect of the jump link topic. For example if the jump-link is related to dealers in the products/services, then the users may be asked to provide comments, positive or negative, regarding listed dealers, or to add or subtract dealers. This input could be maintained in a bulletin format or in some form of a chat room format, and be thus continually supplemented and modified over time.

The jump link topics can also provide an avenue to on-line versions of published works, such as, in the example discussed herein, the “N.A.D.A. Appraisal Guides” or the “Used Car Buyer's Guide” published privately or to government publications and notices such as are issued by the National Highway Transportation Safety Administration technical service bulletins (“TSB's”). Similar materials and other materials made available by, e.g., the Insurance Institute for Highway Safety, e.g., crash test results can also be accessed through provided hyper-links in one or more jump link topic summaries.

Jump link topics can also include information about sub-markets to the markets referenced in the internet superbrands information topics, such as “WHEELS AND TIRES,” “STEREOS, PHONES, ALARMS, ETC.” These could also include bulletin boards and chat rooms of the kind referenced above related to these specific sub-market topics.

As part of the Guest Registry or otherwise, the provider of the internet superbrand web-site can provide users with E-mail addresses on the domain of the provider's web-site, as an inducement to obtain users of the site and/or as a means to communicate with interested users for marketing and like purposes, either by the web-site provider of companies who are, or whose products are, advertised, linked abstracted or the like on the internet superbrand web-site. The Guest Registry can also serve as a bulletin board itself and provide comments in general about the internet superbrand web-site or topic on the jump links list, or the like, with a hyper-link to the E-mail address of each “Registrant” for response to the inquiry/comment of the “Registrant.”

By selecting one of the jump link topic hyperlinks, e.g., “Got a Lemon? Get AUTOPEDIA's 4 Star Award Winning Lemonaid!” listed in the jump link topics list or from a hyper-link embedded in the summary of the jump link topic, the user is connected to a web-site, e.g., “Lemon Law Information and Sites” a past winner of “Yahoo's” Internet Life's 4 Star Award. This site may include comprehensive information about the lemon laws in general or of specific states in particular. It can include a search engine entry format to search the “Lemon Law” web-site or the web in general for more information specific to key words contained in the comprehensive discussion materials or otherwise. The comprehensive discussion materials may contain hyper-links to specific information such as specific statutory language, legislative history of such statutes, articles and court decisions interpreting such statutes, etc. Also linked may be self-help materials on how to get relief under the respective statute. The detailed discussion information may include topical information, e.g., “50 State By State Lemon Law summaries,” or “info-mercial” information, e.g., “CARFAX Lemon Check,” from which a service may be directly obtained or “Center for Auto Safety Lemon Lawyer Referral” which lists service providers or manufacturer-provided good will garnering information, e.g., Mazda RX7 Lemon site. It may include a link to a step by step self help site, e.g., “Okay, you think you have a lemon. Now what?”

Detailed discussion materials may be provided by the provider of the internet superbrand site or may be collected from other sites or solicited from advertisers. In the latter example, for instance, a discussion of the: “Magnuson-Moss Warranty Act” may be provided by, e.g., the “Consumer Law Center, Lemon Law Attorneys, with a hyper-link directly to that organization's web page as part of the credits for providing the detailed discussion material.

Throughout the web-site there may be provided on any given web-page convenient browsing selector buttons, e.g., “Previous Page,” “Back to Lemon Home Page” or “FREE CARFAX Lemon Check.” Selecting the latter, e.g., can access a web-site where the user can obtain information about a vehicle, identified by the Vehicle Identification Number (“VIN”) relating to such things as previous fire, flood or accident damages, instances of odometer fraud, past multiple owners, salvage history, etc. the provider of this service then has an E-mail link to the user and can offer other related information/services for a price to the user. This webpage has an input window for the user to enter, e.g., the VIN and, e.g., the user's zip code to identify the geographical location of the user.

The internet-superbrand web-site can also have a product/service provider registration page with input windows for the prospective registrant for a particular list on the web-site, e.g., dealer, lemon law attorney, automotive manufacturer, automotive accessory manufacturer, etc. to list the company, address, telephone, E-mail and the like. This input could include as well specific contact people for the company. In addition, the input information can include a brief summary of the company and its product(s)/service(s).

Clicking on another of the jump link topics, e.g., can bring the user to a web-page maintained by the provider of the internet superbrand web-site, e.g., “WARRANTIES.” Here the user can be provided with detailed information regarding this jump link topic, and can have access through embedded links to such sub-topics as “extended warranties,” legal recourse, e.g., through “lemon laws,” and the like. The access can be informational, e.g., to an “Extended Warranty Checklist” page or commercial to an “Extended Warranty Company Directory.” The “Extended Warranties” page can have further detailed information about such warranties, as well as the hyper-links just referenced and, further include navigational buttons, e.g., “Next Page” and “Previous Page.” The “Extended Warranty checklist” page can itself have further detailed information concerning extended warranties. This page, as with all pages that have references through hyper-link to commercial sites can have a recommended list of vendors, provided, e.g., by the provider of the internet superbrand web-site. It can also have a hyper-link to the Directory and Home pages just referenced and the navigational buttons just referenced.

The Extended Warranty Company directory page can have a list of companies providing the referenced product(s)/service(s) and can also include a list of recommended vendors provided by the provider of the internet superbrand web-site. this listing page can also have a navigational button to a the registration page as discussed above, i.e., “ADD-A-LINK” where the party accessing that page can add itself to the listed companies, but not modify the list of recommended companies as recommended by the provider of the internet superbrand web-site.

By clicking on another of the possible jump link topics, e.g., “WHEELS” the user can be directed to a page with a listing of topics related to “wheels,” e.g., “Manufacturers/Distributers,” “Retail Outlets,” “Hubcaps,” etc.

The provider of the internet superbrand web-site may conveniently provide a listing of all or substantially all of the hyper-links contained within pages throughout the various portions of the internet superbrand web-site, or some portion of those, e.g., dictated by percentage of access selection by users or the fact that the hyper-link is new or refers to a site/page with updated content. This page also can have a reference button to “ADD-A-LINK” for third parties to add their listing to a page and therefore to this list. The pages that have significant content regarding product(s)/service(s) can be linked to a bulletin board style page where prospective consumers can review and/or solicit the comments of other purchasers of the particular product/service, e.g., an “AUTOPEDIA™ Tire BBS.” This could also include reference to other sites/pages with information regarding tires, e.g., “Tire Opinion Surveys,” which can include surveys in general and surveys of users of the internet superbrand web-site sites/pages relevant to the topic about which the survey had been conducted. This page/site may include hyperlinks to e.g., “Automobile Tire Care and Safety,” :RV Tire Care and safety,” “Tire Industry Safety Council Press Releases,” “Sidewall Information,” Proper Inflation,” Tire Retailers,” Tire Manufacturers,” and the “AUTOPEDIA BBS,” and “AUTOPEDIA HOME PAGE,” and other like pages/sites. A page/site such as “sidewall Information” can contain further detailed information about what appears on the sidewalls of a tire and what it all means, as well as links, e.g., to guides, other informational materials and web-sites, such as the TISC Home Page, as well as to the other cross-reference sites/pages mentioned above. Reference may also be made by hyper-link to the sites of providers of software that the user may wish to download for demonstration and/or purchase or license, e.g., “Expert Lease Pro” for evaluating and comparing terms in automotive leases.

A directory, e.g., a dealer directory page can give the user a directory by state and city of dealers for a particular product/service. Such directories may also be broken down by manufacturer, e.g., Ford, GM, Lincoln/Mercury, etc. This can include a listing or a hyper-link to a listing of recommended dealers. The recommendation can be provided with a statement of the policy of the internet superbrand provider regarding the placement of a dealer on, e.g., a recommended dealer list, i.e., the qualifications that the dealer must meet to become recommended by the provider of the internet superbrand web-page. This page can also contain an input screen or a hyper-link to a site/page with an input screen for users to comment on either the listing of a dealer on the recommended list or the failure to list a dealer on the recommended list. This can include a narrative box for the user to tell his/her “story.”

As another example of the system of the present invention, there can be a “SPORTSPEDIA” web-site. The opening or home page can include a listing of contributing writers/editors on particular subjects within, e.g., the sports world, e.g., auto racing, college football, basketball, etc. The home page can also have a listing of links, i.e., hyper-links, to a listing of topics, or to newly listed topics, or most frequently accessed topics, or some combination of the above. This can include, e.g., reports on a past golf tournament sponsored by the foundation of a sports figure, upcoming support for an organization, e.g., “Special Olympics” from the proceeds of the tournament and information about the foundation and its upcoming activities. These need not be clustered together as such, but may include other sports related hyper-links, e.g., to reports about an auto racing event, photos from a recent sporting event, and, services provided buy the internet superbrand web-site provider, e.g., an E-mail account at the sites domain and such things as bulletin boards. Webmasters or Owners of other web-sites can submit their site to become an official or recommended “SPORTSPEDIA” site and/or can advertise on the “SPORTSPEDIA” site. The Home page can also contain links to information about the provider of the “SPORTSPEDIA” web-site, advertising on the site, the BBS, shopping on the site and/or the domain E-mail, as well as links to specific sports topics relating to specific sports fields, specific teams, and other forms of feature presentations.

By selecting, e.g., the topic of the sports figure's foundation, the user can be taken to a web-page for the foundation, which may have hyper-links (or navigational buttons) to pages/sites relating to, e.g., the sports figure's annual charity golf tournament, teaching camp, donations to the foundation and, even including a business with which the sports figure may be associated, e.g., “Touchdown Real Estate.” This web-site can further include input pages for a user to register, over the Internet, for the golf tournament or submit a pledge for a donation to the foundation, and further to information about the purposes for which the foundation spends the money contributed. Registration for the sports figure's teaching camp can also be done over the Internet on this web-site.

The web-site can accommodate the usual type of banner advertising and, e.g., a bulletin board or several on related sports topics. It can include a search engine for searching the web-page or the internet in general, or the like. Further links can be provided, e.g., to the web-page for “Special Olympics,” of the “Long Beach Grand Prix,” or to related foundations or donation receivers, e.g., “Greatergood.com,” where the user can both shop and donate. The web-page of the business associated with the sports figure, e.g., “Touchdown Real Estate,” give the user the opportunity to shop over the Internet to purchase goods/services from the respective business.

In this manner, the user can access a web-site relating to a particular topic and its related subtopics, through the selection of a site identified by an internet superbrand designator, i.e., “______pedia,” e.g., “AUTOPEDIA” or “SPORTSPEDIA.” The user is then given access, through various levels of detail to information organized within the site in a reference-work format, topic and sub-topic, with cross references among listed topics and subtopics and access to additional external sources of information through hyper-link to other web-sites and/or pages thereof. Throughout the related sites and pages are also links to other pages/sites where the user can conduct E-commerce transactions and order/purchase goods and/or services, and/or obtain further information about same.

An according to the present invention constitutes a Cyberspace Technology that provides an E-Commerce solution to many existing profitability and sustainability issues confronting providers and sellers of products and services on the Web. A Information Superbrand Matrix resolves inefficiencies in the existing Internet Protocol within the Domain Name System (“DNS”) at least at two levels. First, a Information Superbrand Matrix addresses existing inefficiencies in the functional labeling of specific URLS or “Domains,” by use of the “Superbrand” construct. Second, the Information Superbrand Matrix addresses existing inefficiencies in the organization and relationship of multiple URLS, hostnames, or “Domains,” by the utilization of a “domain matrix” or “domain web,” analogous to a “Domain Tree.”

A superbrand domain tree according to the present invention departs from current cyber-space utilization technologies and their implementations regarding the functional labeling of specific URLS, hostnames, or “Domains,” by use of the “Superbrand” construct. The organization and relationship of multiple “Superbrand Domains,” by deployment of the “Domain Tree” matrix or web, provides an E-Commerce solution, which is both profitable and sustainable.

A basic definition for a superbrand is a name that is:

1. Self-defining in that it creates instant consumer expectations, you instantly know what it is;

2. Self-branding in that it projects maximum credibility, authority and consumer trust, you instantly have a set of positive expectations;

3. Self-positioning in that it occupies a superior or elevated position in the consumer's mind;

4. In addition, it defines or epitomizes its market segment in that it is perceived by consumers as the most comprehensive and authoritative resource they can trust, there is an instant tendency to trust and believe.

A superbrand provides an insurmountable and permanent competitive advantage because it instantly and automatically generates powerful consumer trust and credibility in the sense that it can provide a critical key to capturing consumer transactions. It doesn't require nearly the effort or expense associated with normal branding and it is an asset that competitors can not duplicate.

A superbrand according to an aspect of the present invention can also provide the foundation for a unique business model that converts consumer expectations into transactions more efficiently and effectively than any other existing model. The template business model formula for implementing a typical superbrand domain is:

1. The superbrand, which attracts the consumer and creates a defined expectation in the consumer's mind.

2. Sufficient content at the site associated with the superbrand so that the consumer's expectations are fulfilled, thereby generating consumer trust.

3. Complete market-related vendor listing offering a wide variety of transaction opportunities.

4. Expert review and recommendation of “the best” vendor(s) to the consumer, which also serves to trigger transactions.

5. Automatic programming that supports the following, e.g., link exchanges, vendor listings, vendor and member auto-site building, vendor locators, secure shopping cart and other transactional improvement related systems, bulletin boards, chat rooms and like user amenities.

Deployment of superbrands for specific Domain Names, in the functional labeling of specific URLS, hostnames, or “Domains” can provide a competitive advantage in particular market sectors or industries. A Domain Tree according to the present invention constitutes a synergistic approach to deployment of multiple superbrands for specific Domain Names, across the entire ranges of markets and industries available on the Web both today and into the future. A superbrand domain tree can employ a matrix or web of multiple superbrands. Each superbrand is designed to define or epitomize its market segment, at both generic and specific levels of information organization. For example, human consumption can be divided into both foods and beverages. Beverages can be divided into wine, beer, etc. Wine could be divided into Cabernets, Chardonnays, etc., and so forth, e.g., “Winepedia,” “Chardonnaypedia,” and “Californiachardonnaypedia.” Each product or service category can be similarly matrixed with a superbrand, depending on criteria for the meaningful indexing of the specific products and services.

A user of an Information Superbrand Matrix can begin access at greater or lesser (generic and specific) levels of information organization, depending on factors such as experience and specific search criteria. Likewise, a user can deploy search engines or “assistants” at higher or lower levels of information organization. A superbrand domain tree also allows a user to develop increasingly targeted information requests as familiarity with the technology and information organization increases. Likewise, an Information Superbrand Matrix allows a provider/seller of information, goods or services to micro-target specific types of users at greater or lesser (generic or specific) levels of information organization, enhancing the ability of provider/sellers to reach intended Users. For example, the provider/seller can receive information regarding the path(s) through which customers or prospective customers traveled to arrive at the ultimate transactional site of the provider/seller, or other user information or combined with other user information to profile users and their access to the transactional site(s).

An Information Superbrand Matrix similarly can enhance the ability of a provider of a host IP in technical aspects, such as load balancing, or employment of market specific technologies and data systems. For example, professional users (i.e. doctors or nurses) could be accommodated with more detailed information including highly technical medical terminology, while the prospective customer that is a layperson may be given more generally understandable information. The implementation utilizing currently available technologies allows users to define their own superbrand domain tree interface. Intelligent interfaces can allow users to conduct “intelligent” searches based on natural word criteria.

Because the Information Superbrand Matrix can be founded upon a matrix or web of multiple superbrands, the system has inherent advantages relating to exclusivity of utilization of such a web and its contents. This can insure that the superbrand domain tree can grow and expand as demands for exceedingly targeted information arises within given market structures and segments.

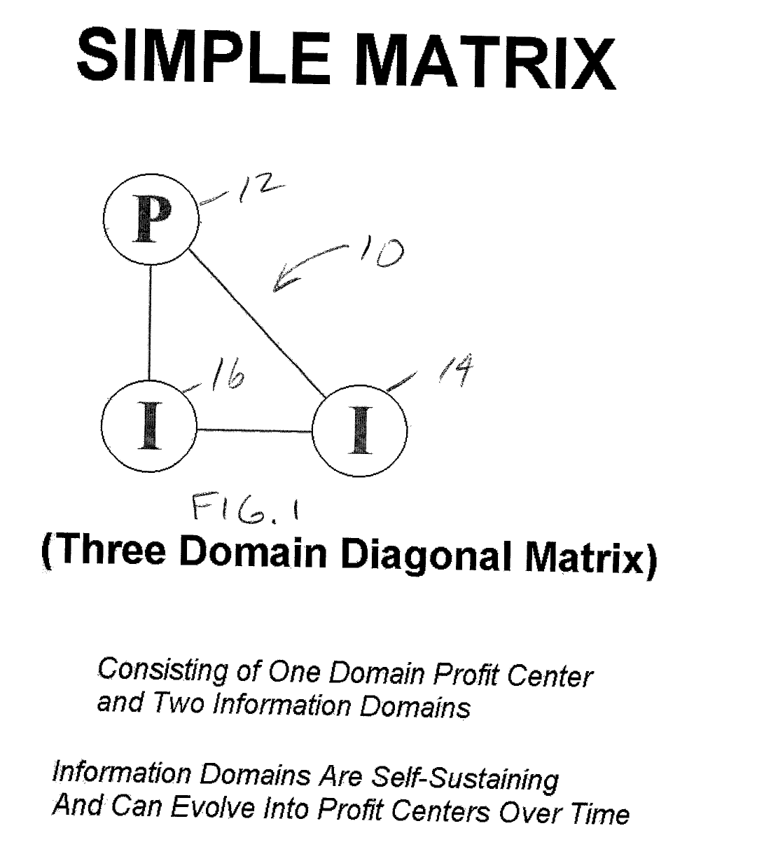

The present invention can utilize “information superbrands” to establish an “information superbrand matrix” of subject-based, information reference sources comprised of “all the information that exists” in each respective field and market segment selected for the matrix. Turning now to FIG. 1 it can be seen that a matrix can consist of a collection of, e.g., three Internet websites, 12, 14 and 16, which can be identified by domain names, each utilizing “information superbrands”. Each website or “domain”, 12, 14 or 16 within the matrix 10 can be organized and managed by “expert human information architects” with the objective to fully collect, catalog and define the “information organizational structure” for that particular segment.

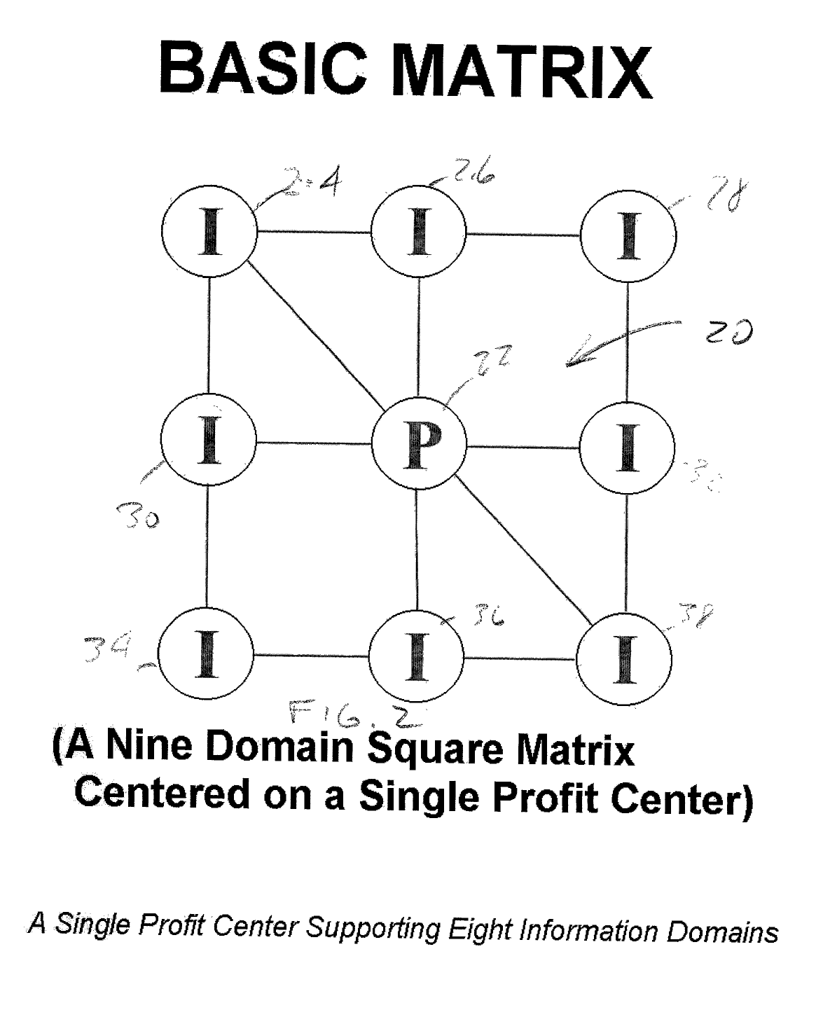

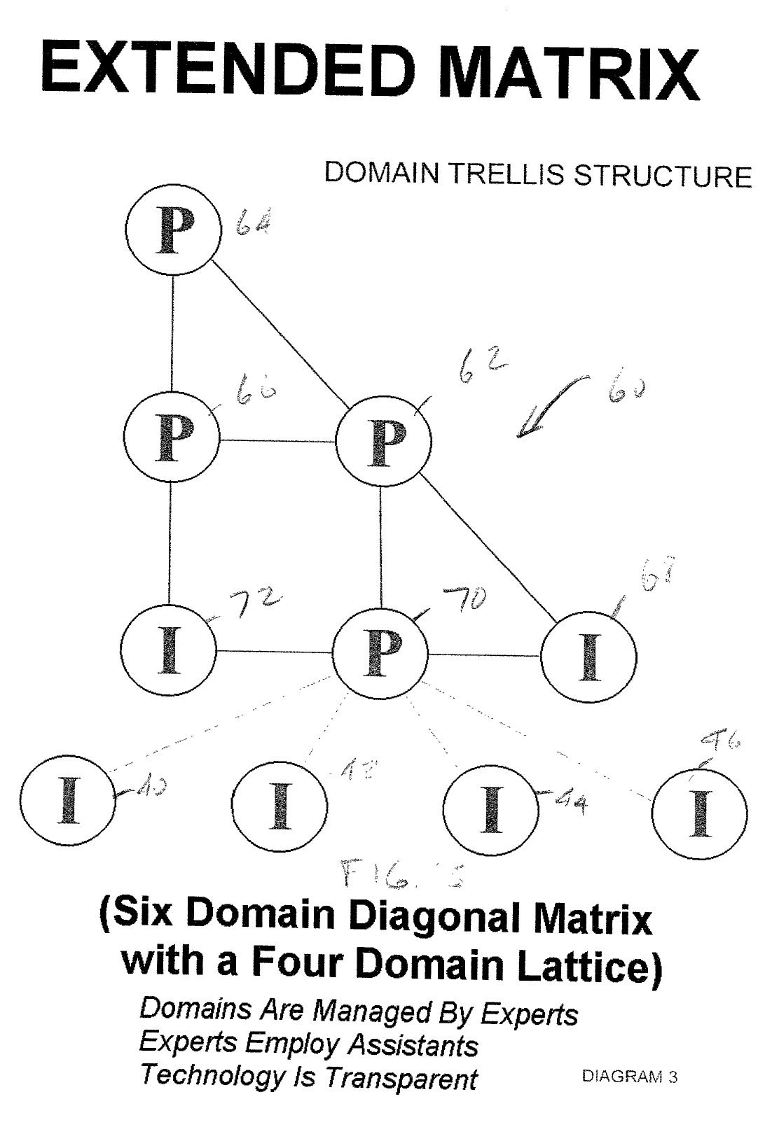

In accordance with a “superbrand matrix protocol”, the domains 12, 14 and 16 can be assigned “information positions” in an “Information Superbrand Matrix”, such as matrix 10 in FIG. 1. Domain information architects in turn can refine their respective positions, the relationship of their individual domains 12, 14 and 16 and the “information” for their segment, relative to all other domains within the matrix 10. Once established, the collection and definition of information within each domain 12, 14 and 16 can continue at ever increasing rates, because the matrix infrastructure facilitates a group-driven process resulting in an “intercreative” and self-organizing information system. The expansion of each domain “information” segment by its architect is further enhanced by this process of group creativity, group intuition, and harmony among the entire “information matrix”. Implementation of the information superbrand matrix 10 can proceed with readily available “redundant, proven technologies”, including a broad spectrum of all search engine technologies available now and into the future. Like the Internet itself, the information superbrand matrix 10 can continue to emerge, enlarge, expand, fill in, gain complexity, and evolve, indefinitely, as is shown for example in regard to FIGS. 2 and 3. In the three domain diagonal matrix shown in FIG. 1, the domain 12, designated as “P” can be a single profit center within the matrix 10 as shown, with the domains 14 and 16 being information domains, supplying information to those who access the domain 12. These information domains, 12 and 14, however, can be self sustaining and can evolve into profit center domains over time.

A matrix with n rows and n columns is called a “square matrix” of order n. Such matrices can assume rectangular proportions, as shown e.g., in FIG. 2, or even diagonal proportions. That is to say the matrix would exhibit mathematical properties relative to its diagonal. Conceptually this could be further refined into a triangular matrix or even a tri-diagonal matrix. Essentially, matrices can assume very complex shapes and forms without losing the usefulness relative to their mathematical properties.

In this simple form of matrix 10, a three domain diagonal or “triangular” matrix is implemented. The domain 12, “P”, can consists of an “auto” or “automobile” website. The “I” domain 14 could then consists of a “sports” website, and “I” domain 16 could then consist of a “travel” website. From a semantic perspective, an “auto” website can consist of information about automobiles, a “sports” website can consist of information about sports, and a “travel” website can consist of information about travel. Each of these subjects can have a semantically derived meaning for a person using the respective websites. And, the meaning might differ slightly from one user to another, depending on backgrounds, experience, and culture. However, generally automobiles are machines (usually four-wheeled) for traveling on roads. Travel usually means simply going from one place to another without being restricted to a specific form of transportation. Sports normally can be any one of a number of activities or experiences that provide enjoyment or recreation. Semantically speaking automobiles, travel, and sports are each unique concepts. Neither is a subcategory of the others, however, each exhibits certain semantic relationships to the others. Automobiles can be used for travel, but in turn are not indispensable to travel because clearly one can travel without the use of an automobile. Similarly, automobiles themselves are almost always used for travel, but it is possible for one to “collect” automobiles (possibly antiques) that will be displayed but never used for travel. And, many of the characteristics of automobiles are genuinely independent of their travel function (i.e. style, color, or type). Sports and travel involve similar interrelationships; one can travel to sporting events, or certain types of travel (such as yacht racing or mountain climbing or even automobile driving) could be considered a sport.

Therefore, once automobiles, travel, and sports are joined as part of a common matrix 10, it is possible to define an almost unlimited number of semantic interrelationships among the three domains. Moreover, it is possible to assign mathematical values to the semantic interrelationships. For example, autos could be class 01, sports class 02, and travel class 03. A symbol string could then reflect the primary class of each domain, and by use of a one row array the relative strength of the semantic relationship to all other domains in declining importance. Autos might be 010302, travel 030102, and sports 020103. These value arrays, reflecting semantic relationships can be useful to search algorithms as well as for linking cross-relevant information common to multiple domains. For example, a system could evolve for semantic linking of auto racing between the auto and sports domains.

Thus, another basic domain matrix can consist of domains arranged in rows and columns. Turning to FIG. 2, there is shown such a basic matrix 20 which can be made up of a profit center domain 22, surrounded by 8 information domains, 24, 26, 28, 30, 32, 34, 36, and 38, which can be interconnected or linked to one or more respective others of the information domain and/or to the profit center domain, either in row and column fashion or along a diagonal, as illustrated diagrammatically in FIG. 2. The matrix 10 or 20 structure then can become the foundation for designing or “architecting” the semantic interrelationship of domains within the matrix 10 or 20.

As the number of domains increases, and the complexity of the matrix itself can evolve, and the semantic properties of the matrix can become exceedingly complex. The semantic interrelationships can in turn be defined by the individual architects either working collectively or from the perspective of each domain independently. Coordination among domains or groups of domains can be made readily available, but without limiting specialization within any single domain or subgroup of domains. Thus, there are many different levels that can be involved in the semantic organizational process. However, a synergy or mutually enhancing coordination remains.

Once established, the collection and definition of information within each domain can continue at ever increasing rates, because the matrix infrastructure facilitates a group-driven process resulting in an “intercreative” and self-organizing information system. The expansion of each domain “information” segment by its architect is further enhanced by this process of group creativity, group intuition, and harmony among the entire “information matrix”.

The architecture of the matrix can also assume much more semantically complicated substructures. In essence, the “Matrix” can become a set of matrices. For example, turning to FIG. 3 there is shown that a four domain “lattice” (information domains 40, 42, 44 and 46) can be attached to a single domain 70 within a matrix 60 that can be composed, e.g., of a triangularly connected set of three profit center matrices 62, 64 and 66 with the domain 62 directly connected to the profit center domain 70 and an information domain 68 and the domain 66 connected directly to the information domain 72 and indirectly to the profit center domain 70 and the matrix 40, 42, 44 and 46. If domain 70 were, e.g., an “insurance” website within the matrix 60, consisting of information about insurance, the four additional domains 40, 42, 44 and 46 could be attached to that primary insurance domain 70. These domains 40, 42, 44 and 46 could consist of separate domains for “auto” insurance 40, “title” insurance 42, “property” insurance 44, and “liability” insurance 46. Like the primary “insurance” domain 66, the sub-domains 40, 42, 44 and 46 within the domain lattice can be semantically interrelated to all other domains in the matrix, or at least those domains where semantic relationship is meaningful.

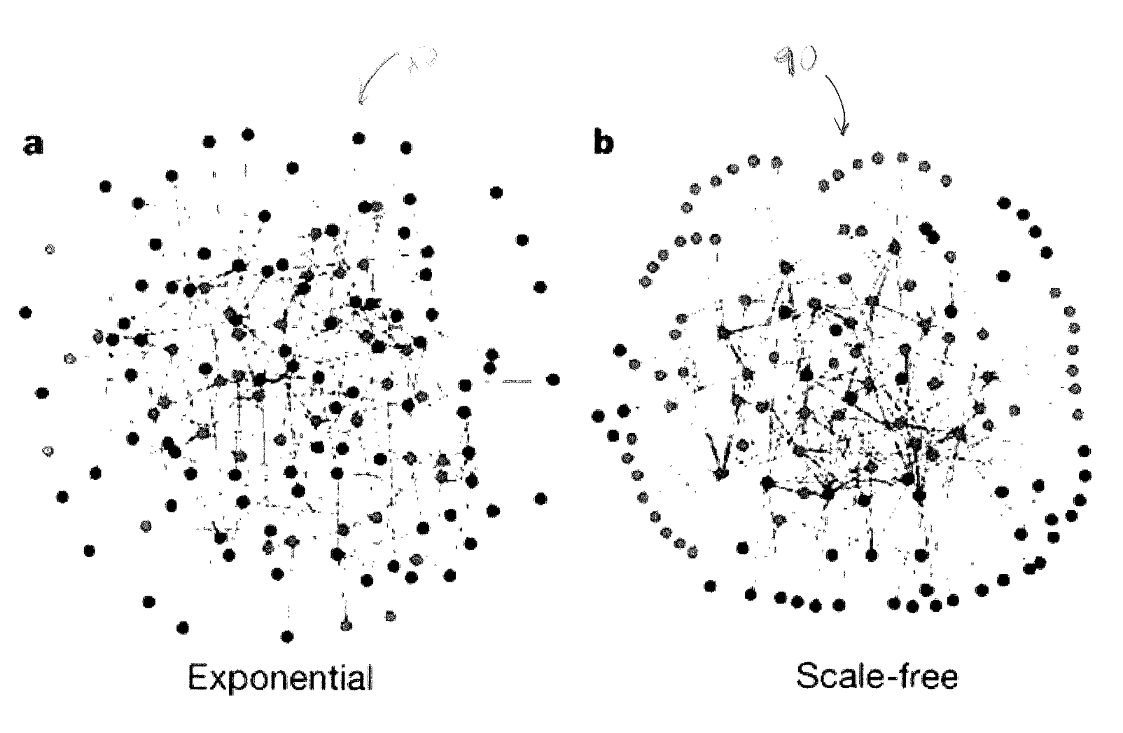

Turning now to FIG. 4a there is illustrated an exponential web makeup 80 in which profit center nodes shown in red are almost randomly interconnected with information domains shown in green and other domains shown in black. The network 80 is more or less homogeneous, where most domain nodes have about the same number of links to other domain nodes. Turning now to FIG. 4b there is shown an illustration of a scale free matrix 90 in which some information domain, shown in green, and other domains shown in black, remain somewhat randomly interconnected, however, many information domains, shown in green, are matrixed in a lattice format, in the manner of FIG. 3 to profit center domains, shown in red. In the scale-free network 90, many of the information and other nodes have about the same number of connections, e.g., two to four, but some matrices have a larger number of connections in the matrix layout. Thus for example, assuming that the most connected nodes in FIG. 4a were also profit center nodes in the matrix, designated by red, between them they link to only about 27% of the other and information nodes in the matrix of the network 80. On the other hand, as can be seen in FIG. 4b, the five most connected nodes (profit center domains, shown in red) are connected to a substantially higher percentage of the other and information nodes, on the order of 60 percent thereof, due to the utilization of the lattice structure. In both networks, however, there are shown 130 nodes and a total of 215 links, demonstrating the differences between an exponential connection and a latticed connection.

The overall information system generated by adding or “attaching” domain lattices can be referred to as a “domain tree” or a “domain trellis”. The notion of a “domain tree” reflects the fact that the “matrix” may not be entirely “pure” from a mathematical point of view. The end product is perhaps closer to an organic system, but would still retain certain useful components and hierarchies, which function on a mathematical model. The end result can approximate an artificial neural network implemented in Internet domains. But unlike an artificial neural network which is designed to mimic the thinking of a singular entity composed of multiple pathways, the matrix incorporates a multiplicity of many independent domains or “thinking entities”.

In the context of the “pedia” or “encyclopedia” superbrand, the matrix, e.g. 60 or 90 demonstrates a radical extension of the semantic “duality” in the encyclopedic categorization of information. Normally, an “encyclopedia” can be either: (1) a book or set of books giving information on all or many branches of knowledge; or (2) a similar work giving information in a particular field of knowledge. Within the “pedia” matrix it can simultaneously be both. Each domain operates as a specialized work giving information in a particular field of knowledge. The entire matrix covers information on all or many branches of knowledge.

Prior to the Internet and the World Wide Web, when information gatherers relied on pen or print to paper, information compilations were restricted to one style of encyclopedic information compilation or the other. With the Internet, electronic language and digital text facilitate more complex gathering, organization, and retrieval of information. Book words tended to be closed, definitive and linear deflecting the scope of human thought. Words on the web (through use of hyperlinks, hypermedia, and other technological characteristics like the DNS) take on a new sense of interactive dynamics. Information on the web simultaneously becomes both more immediately specialized, yet ever more intricately linked to all other information available. Through the use of information semantics the information superbrand matrix implements a structure and architecture for enhanced information access to significantly extend all aspects of human knowledge.

Matrix Navigational Features: The information superbrand matrix is also conducive to semantic based information “friendliness” which is conducive to users finding useful data.

Because websites are coordinated within the matrix, protocol can provide for certain aspects of common “look and feel”. A user familiar with a website in one subject is more likely to be already acquainted with task functionality when he or she visits another website within the matrix for the first time.

The implementation of available technologies will allow customers to define their own matrix interface. “Look and feel” can then be customized across the matrix to specific user capability. Professional users (i.e. doctors or nurses) can be accommodated with more detailed information including highly technical terms, while the layperson is given highly understandable information. Intelligent interfaces already allow customers to conduct “intelligent” searches based on natural word criteria, but in the matrix because the customer is individually already defined in at least one subject degrees of usefulness can be readily accommodated in all other subjects.

Because its information structure is semantically driven the matrix is predominantly independent of existing technology. The matrix is “non-technology”, and implementation of the information superbrand matrix can proceed with readily available “redundant, proven technologies”, including a broad spectrum of all search engine technologies available now and into the future.

The matrix enhances the ability of the host Internet Protocol (“IP”) in technical aspects, such to balance loading, or employ market specific technologies and data systems.

Because the matrix is founded upon a web of multiple information superbrands, the system has inherent legal advantages arising from intellectual property protections. This insures that the matrix can grow and expand as demands for exceedingly targeted information arise within a given market.

Brand Enhancement: In addition to the superbrand construct, the matrix also deploys semantically derived branding characteristics which are valuable to vendors and sponsors of the matrix. Most often these vendors and sponsors already have their own product or service brands. Typically these brands are coined and have not semantic significance, unless the customer already has a brand awareness and image. Here, there is a distinction between the “information” superbrands deployed as the domain or website names, and the brands relied on for the “brick and mortar” products and services.

For a vendor of products and services, the term “Brand Equity” is premised on the notion that a brand possesses equity to the extent that consumers are familiar with the brand and have stored within their memory warehouses favorable, strong, and unique brand associations. Brand awareness involves the issue of whether a brand comes to mind when consumers think about a particular product category and the ease with which the brand name is evoked. This can be categorized as both brand recognition and brand recall.

Brand “image” involves the type of associations that come to the consumer's mind when contemplating a particular brand. There are various types of brand associations, such as attributes, benefits, and attitude (the customer's overall association). Benefits can be functional, symbolic or experiential. Image can involve the favorability, strength and uniqueness of brand association.

Therefore, in its most fundamental form brand equity is enhanced by: name awareness, positive associations, perceived quality, and strong brand loyalty. This is referred to as “Brand Enhancement”. The information superbrand matrix represents one of the most radical brand enhancement mechanisms available to the brick and mortar vendor who desires to adapt to an Internet information economy.

Early brick and mortar advertisers on the web typically relied on banner ads and “click through's” to achieve brand enhancement.

The assumption was that an attractive banner ad would lure the consumer to “click through” to the advertiser's site, where the user would find more relevant information tending to enhance product acceptance or purchase. The recent tendency has been for more and more companies to attempt to brand their company name or product brands as domain names, and sell products or services in that fashion.

There have been multiple problems with both the banner ad and click through marketing, and the attempt to brand on the Internet. With banner ads, it is becoming apparent that most Internet users are not susceptible to web advertising. Click through rates in general have declined significantly as more users come onto the Internet. There are now too many banner ads largely ignored, and the falling revenues for banner ads reflect the doubt as to whether this type of advertising can sustain websites in the future.

Likewise, putting a company's brand name on a Website doesn't make it an Internet brand. Real-world, brick and mortar brands are quite different from virtual-world Internet brands. Real-world brands should generally not be Internet brands. The Internet is a medium uniquely situated to information brands rather than product brands.

Lastly, self-aggrandizement and glorification very often does not work well in the customer's mind. On the Internet, when the vendor comes face to face with the customer, the vendor is in its most vulnerable position. The customer is often least likely to rely on or trust he vendor's evaluation of its product or service merits (even if such self-evaluation is genuinely correct).

The matrix permits a third party approach to brand enhancement and product evaluation: semantic brand enhancement. Information superbrands enhance the vendor's own brands by uniquely providing third party independent review and recommendation. From the customer's perspective the superbrand offers the most trustworthy source of reliable information about products and services. From the vendor's perspective, the superbrand acquires and captures a targeted audience most efficiently and cost effectively. The Website operator through the domain architect acts as a balancing force to the competing needs of customer and vendor.

Independent Consumer Data Gathering and Retrieval:

Similarly, customers are much more likely to identify their true needs, interests and purchase capabilities to an independent consumer oriented representative, rather than to the vendor directly. Yet, regardless of how trusting or untrusting the customer is, or how trustworthy or untrustworthy the vendor is, it is often the case that complete and extensive information about the customer's needs makes the purchase a better fit for the customer. The matrix facilitates gathering and retrieval of useful consumer data by interposing such a third party independent authority. The positioning of the gathering authority is furthered because from the customer's perspective or mind the superbrand exemplifies the most trustworthy contact for this task.

Independent Data Administration: Information assists the vendor by generating expectations for brands such that the consumer is more willing to try the product when in an experimentation mood (packaged goods) or is more likely to investigate the product further. Here, information assists the vendor in selling more product or services. However, information also assists the vendor to provide the consumer with the most “correct” and “useful” information, that is to say information which mostly closely approximates the consumer's exact needs for information so as to effectively evaluate purchases. In this sense, information better satisfies the needs of the consumer. The matrix balances the use of data between the conflicting interests of the consumer and the vendor.

Complex Adaptive Properties: The Internet Superbrand Matrix embodies all of the crucial and common properties of a complex adaptive system. It involves a network (“matrix”) of many domains organized by information architects (“agents”) acting in parallel. Each architect exercises almost unlimited discretion over his or her own domain, therefore control of the system (“matrix”) tends to be highly dispersed. The coherent behavior of the system (“matrix”) arises from competition and cooperation among the architects themselves.

The matrix can have many levels of organization, with domains at any one level serving as the building blocks for domains at another level. Moreover, the relationship between domains can be constantly revised and rearranged by their architects. The many semantic niches within the matrix, can be particularly exploited by an architect adapted to managing that niche. The information superbrand matrix is never completed, it is always unfolding, always in transition characterized by perpetual novelty.

Like the Internet itself, the information superbrand matrix can continue to emerge, enlarge, expand, fill in, become more complex, and evolve, indefinitely.

The organization and relationship of multiple information superbrand domains, through deployment of the matrix, provides an E-Commerce solution, which is both profitable and sustainable.

Synnoetics: The human-computer symbiosis of the matrix.

In operation the present invention can provide users with a catalogue of products/services in which they may be interested through an access vehicle that is in essence a reference source for information organized in topical category and subcategory. The topics and subtopics can contain increasingly more detailed information about the categories and sub-categories and at the same time provide increasingly more focused lists and references to providers and to specific products/services of such providers, and at the same time to increasingly more focused transactional opportunities for both the users and the providers.

This specialized organization of reference materials into the categories and subcategories specific to a particular broad topic, e.g., a vertical market structure can facilitate searching within such a market/information structure through a more structured system of category nesting and cross-referencing. For essentially every screen that a user accesses, which can be accessed through utilization of all of the commonly known interface methods, including keyboard input, mouse input, voice input, etc., there can be an underlying transactional layer. The topical sites can provide a basis for interlocking related topical sites and additional categorically specific information and transactional access. Instead of simply being provided with an access through which to pass, as with a portal on the Web, the site according to the present invention remained linked backwards and forwards so that the user can pass from the generic to the specific and back up the line to the generic, or even to related specific categories that may not be necessarily more specific than the site at which the user presently resides.

Selections of categories, topics, vendors, or the like can be facilitated by images in addition to or in replacement of text. The information sources for the topics/categories and sub-topics/sub-categories can conveniently be placed upon a single server or a highly linked and grouped set of servers to facilitate the recovery of the pertinent information when crossing from one topic to another or moving up or down the generic/specific ladder of categories/topic and sub-categories/sub-topics.

The invention utilizes “information superbrands” to establish an “information superbrand matrix” of subject-based, information reference sources comprised of “all the information that exists” in each respective field and market segment selected for the matrix. The matrix consists of a collection of Internet websites identified by domain names utilizing these “information superbrands”. Each website or “domain” within the matrix is organized and managed by “expert human information architects” with the objective to fully collect, catalog and define the “information organizational structure” for that segment.

An information superbrand domain (i.e. AutoPedia, SportsPedia, etc.) can be a website assembled from the following components.

### (An Information Pyramid)

### THE EXPERT

### +

### THE SUPERBRAND

### +

### THE INFORMATION

### Locate and publish all of the subject information available in the world.

### +

### PROVEN TECHNOLOGIES

In accordance with a “superbrand matrix protocol”, domains are assigned “information positions” in an “Information Superbrand Matrix”. Domain information architects in turn refine their respective positions, the relationship of their individual domains and the “information” for their segment, relative to all other domains within the matrix. Once established, the collection and definition of information within each domain can continue at ever increasing rates, because the matrix infrastructure facilitates a group-driven process resulting in an “intercreative” and self-organizing information system. The expansion of each domain “information” segment by its architect is further enhanced by this process of group creativity, group intuition, and harmony among the entire “information matrix”.

### (Information Superbrand Matrix)

### 3 OR MORE SUPERBRAND DOMAINS

### +

### PROTOCOL

### =

### INFORMATION SUPERBRAND MATRIX

The matrix architecture allows the adaptation of mathematics to an exceedingly large information system, in which each of the subcomponents (“domains”) can follow slightly different rules of order defined by human experts.

This facilitates cooperation and arbitration between and among the different subcomponents (“domains”) through the use of intelligent human agents (“experts”) to manage the domain relationships. In addition, because the matrix can function with a very simple protocol, with a small or limited number of rules, it can generate an information system of surprising complexity. Like a complex adaptive system, the matrix employs multiple domains (sets of domains managed by their individual “experts”), which are composed of many information niches. Each information domain can be exploited (“managed to evolve into a profit center”) by its expert agent adapted to fill that niche. All of the domain experts change and improve themselves relative to what all the other domain experts are doing, such that the overall information of the entire system is characterized by perpetual novelty and constant expansion. Yet the system never loses its intrinsic organizational properties.

An immediate and full implementation of the information superbrand matrix can proceed with readily available “redundant, proven technologies”, including a broad spectrum of all search engine technologies available now and into the future. Like the Internet itself, the information superbrand matrix can continue to emerge, enlarge, expand, fill in, gain complexity, and evolve, indefinitely.

The invention thus can utilize the Internet as a manifestation of “cyberspace” requires “information architects”. It can be Group-driven, adaptive and self-organizing cyberspace (information) system. It can have application of the Internet Domain Name System through, e.g., the utilization of the Semantic Properties of Domain Names. It can involve multiple definitions of the “pedia” moniker, generic vs. class category. It can employ the above noted Domain Matrix Architecture & Protocol (setting the rules defining etiquette and precedence), and can employ the human-computer symbiosis of the matrix

The “information superbrand matrix” can provide a solution for the Internet's expanding “information marketplace” infrastructure. Using a very simple set of information branding and matrix rules, (the “information superbrand matrix”) can proliferate into a highly complex, highly useful and quite adaptive information system suitable to solving the Internet “branding problem” facing all companies today. The “information superbrand matrix” solution recognizes that there are always only two problems that a business must solve: (1) competition, and (2) declining margins. Both of these have been with us since the beginning of the business age. And there are only two long-term solutions to these problems: brands and endorsements.

A principal benefit of the present invention is a method and system for Internet branding and information biased electronic commerce, which can solve these two problems faced by businesses in the information age. The present invention also specifically addresses the consequences of information overload, in a manner that departs from methodologies of existing portals and search services. With the “superbrand” construct, the present invention can significantly extend the application of ordinary brands, which are nothing more than a “set of expectations” associated with a logo, slogan, or image in the consumer's mind triggered whenever the brand and/or brand category is encountered.

The present invention can provide a more effective branding method for attracting potential customers to an Internet website, and for putting customers in contact with a product or service provider that is focused to the specific needs of the prospective customer from an information perspective. This can dispense with the need for the prospective customer to spend significant amounts of time browsing listed sites, some of which may have little or no relevance to the actual products/services that the prospective customer is seeking, in order to obtain information about, and ultimately purchase products.

The invention incorporates a “Superbrand” which is a brand that is:

1. Self-defining—you instantly know what it is.

2. Self-branding—you instantly have a set of positive expectations.

3. Self-positioning—instantly occupies an elevated position in the mind.

4. Epitomizes the market segment—instant tendency to trust and believe.

The Invention as applied to the Internet and the World Wide Web makes specific use of Information Superbrands which are a subset of “Superbrands”, and generally can be constructed in either one of two ways:

“noun or pronoun + PEDIA—The noun or pronoun Encyclopedia”

### or

“noun or pronoun + PEDIA—The Encyclopedia of noun or pronoun”

Language represents commonness-of-mind among members of a social group. An information superbrand is a specialized form of electronic language, being a readily repeatable embodiment with semantic properties that make it more or less permanent in the minds and memories of humans. In the case of a “Pedia” information superbrand, the semantic properties involve an almost instantaneous recognition that the brand stands for a reliable and trustworthy source of information about a particular subject matter. Moreover, recognition of its meaning is almost universal world-wide from culture to culture, due to the nature of the source word from which it is derived: encyclopedia. The “noun or pronoun” requirement is not strictly grammatical. It can also be represented by any “word” or a “portion of a word” that connotes meaning in the user's mind. An example would be the “cyber” in “Cyberspace”. Thus, it is most simply a “designator” that is suggestive of either a market category, product or subject matter. “Pedia” represents the “superbrand moniker”. This is a component of language with semantic and interactive properties that take advantage of “What's already there” in the user's mind. Thus, superbrands are assembled words from small and readily available components of language, meaningfully translated into some value of expectation. Together with the “designator” the “superbrand moniker” comprises the superbrand “shortform”. “The noun or pronoun Encyclopedia” represents a “full descriptive tag”, that enhances the semantic properties, meaning and derived expectation of the preceding “shortform”.

In cases where the semantic properties of the language components are sufficient, alternatively a simpler form of the information superbrand can be constructed as follows:

### “noun or pronoun+PEDIA”

The invention relies on the Internet Domain Name System which is premised upon the use of Symbol Strings (mathematical notation or language) versus images (spatial and visual). Symbol strings utilized as domain names are in turn biased toward those composed of language with semantic properties that tend to promote human recall. Generic names tend to have little value as domain names because their basic semantic properties usually extend only to a singular meaning: a class of beings or things. Proper names tend to generate more complex expectations, often in the nature of both product and quality. The weakness is such properties may not be widely known. On the Internet, a simple domain name with complex and inherent semantic properties is the most valuable: the Information Superbrand.

We claim:

1. A method for marketing over a network of interconnected computing/communicating devices, comprising the steps of:
providing a web-site that is identified as specific to a market sector;
supplying on the web-site information specific to a plurality of first level topics related to the market sector;
providing within the information specific to a particular first level topic related to the market sector, at least one pointer to a more specific second level topic referenced in the information specific to the first level topic;
responsive to activation of the pointer, providing further information specific to the more specific second level topic;
providing access to E-commerce access to transaction processing with at least one provider of goods and/or services referenced in the more specific second level topic.

2. The method of claim 1 further comprising the steps of:
providing within the information specific to the second level topic at least one pointer to a more specific third level topic referenced in the information specific to the second level topic;
responsive to the activation of the pointer contained within the information relating to the second level topic, providing further information specific to the more specific third level topic;
providing E-commerce access to transaction processing with at least one provider of goods and/or services referenced in the more specific third level topic.

3. The method of claim 1, further comprising the steps of:
providing within the information specific to an nth level topic at least one pointer to a more specific n+1th level topic referenced in the information specific to the nth level topic;
responsive to the activation of the pointer contained within the information relating to the nth level topic, providing information relating to the n+1th level topic;
providing E-commerce access to transaction processing with at least one provider of goods and/or services referenced in the more specific n+1th level topic.

4. The method of claim 1 wherein the network is the Web.

5. The method of claim 2 wherein the network is the Web.

6. The method of claim 3 wherein the network is the Web.

7. The method of claim 4 wherein the identification of the web-site includes a superbrand designation.

8. The method of claim 5 wherein the identification of the web-site includes a superbrand designation.

9. The method of claim 6 wherein the identification of the web-site includes a superbrand designation.

10. The method of claim 7 wherein the superbrand designation includes a market category designator and a superbrand moniker.

11. The method of claim 8 wherein the superbrand designation includes a market category designator and a superbrand moniker.

12. The method of claim 9 wherein the superbrand designation includes a market category designator and a superbrand moniker.

13. The method of claim 10 wherein the superbrand moniker is a suffix.

14. The method of claim 11 wherein the superbrand moniker is a suffix.

15. The method of claim 12 wherein the superbrand moniker is a suffix.

16. The method of claim 13 wherein the superbrand moniker is the suffix “pedia”.

17. The method of claim 14 wherein the superbrand moniker is the suffix “pedia”.

18. The method of claim 15 wherein the superbrand moniker is the suffix “pedia”.

19. The method of claim 1 wherein the step of providing a web site includes the step of providing multiple web sites arranged in a matrix.

20. The method of claim 10 wherein the matrix includes inter-linked profit center web sites and information web sites.

21. The method of claim 1 wherein a website domain name is endowed with semantic properties, embodying semantic branding.

22. The method of claim 19 wherein the information structure of the multiple web sites in the matrix is semantically driven or semantically organized.
